(19) United States
(12) Patent Application Publication
(10) Pub. No.: US 2006/0172751 A1
(43) Pub. Date: Aug. 3, 2006

(54) Method for synchronizing use information of mobile communication terminal and system implementing the same

(75) Inventors: Ho-Sung Son, Gumi-si (KR); Ki-Cheon Han, Gumi-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/232,865

(22) Filed: Sep. 23, 2005

(30) Foreign Application Priority Data
Jan. 31, 2005 (KR) 2005-8622

(51) Int. Cl. H04B 7/005

(52) U.S. Cl. 455/502; 455/41.2

(57) ABSTRACT

A method for synchronizing use Information of a mobile communication terminal and a system are provided. In system and method, for synchronizing use information between a first mobile communication terminal and a second mobile communication terminal including short-range wireless communication units includes requesting connection for use information synchronization to the second mobile communication terminal by the first mobile communication terminal, if a response signal to the connection request is received from the second mobile communication terminal, transmitting use information of the first mobile communication terminal to the second mobile communication terminal, and updating by the second mobile communication terminal use information of the second mobile communication terminal using the transmitted use information of the first mobile communication terminal.

### PRIORITY

This application claims the benefit under 35 U.S.C. §119(a) of a Korean Patent Application entitled “Method for Synchronizing Use Information of Mobile Communication Terminal” filed in the Korean Intellectual Property Office on Jan. 31, 2005 and assigned Serial No. 2005-8622, the entire contents of which are hereby incorporated by reference.

### BACKGROUND OF THE INVENTION

1. Field of the Invention

The present invention relates to a method and system for synchronizing use information of a mobile communication terminal. In particular, the invention relates to a method for synchronizing use information between mobile communication terminals including a short-range wireless communication unit such as Bluetooth and a system implementing the same.

2. Description of the Related Art

Generally, a mobile communication terminal refers to a device for providing a communication function enabling a user to exchange data or communicate with another user while moving. Such a mobile communication terminal comprises a cellular phone, a personal digital assistant (PDA), a personal communication service (PCS) phone, an international mobile telecommunication-2000 (IMT-2000) terminal, a global system for mobile communication (GSM) terminal and the like.

This mobile communication terminal has become greatly popular. For this reason, in consideration of portability, the design of such a mobile communication terminal is tending toward compactness, slimness, and lightness and is advancing toward multimedia capability and more various functions.

Although such a mobile communication terminal is designed to perform a telephone communication function, the mobile communication terminal is providing a short message transmitting/receiving function, a memory function used for storing or searching for phone numbers, a lock function, an alarm function, an area code confirmation function, and a schedule managing function besides the telephone communication function according to developments of communication techniques. In addition, recently, the mobile communication terminal is providing additional service functions such as a camera function, a digital broadcast receiving function, and a game function. Herein, the memory function is used for storing user memo records, a communication record list, a phone directory, transmitted/received messages and the like.

As the mobile communication terminal described above becomes popular and generalized, a user downloads bell sounds or background images, which are output when a call is terminated, through Internet sites and the like, and stores them in a memory so as to make a user's own characteristic distinct.

Meanwhile, data, such as the bell sounds, the communication record list, the phone directory, stored in the memory of the mobile communication terminal cannot be shared with other mobile communication terminals because the data are used only for the corresponding mobile communication terminal.

In addition, when employing a Bluetooth terminal linked with a mobile communication terminal, a user usually puts the mobile communication terminal (a main body) in a user's bag and makes communication or transmits/receives short messages by using the Bluetooth terminal linked with the mobile communication terminal. For this reason, the mobile communication terminal stores use information, such as a communication record list, different from use information of the Bluetooth terminal in the memory.

In other words, when the user intends to communicate with the other party, who was connected with the user through the mobile communication terminal before, by using the Bluetooth terminal again, the user must personally input the phone number of the other party into the Bluetooth terminal so as to place a call because the phone number of the other party is not included in the Bluetooth terminal even though the phone number is included in the communication record list of the mobile communication terminal.

### SUMMARY OF THE INVENTION

Accordingly, the present invention has been made to address the above-mentioned problems, and an object of the present invention is to provide a method for synchronizing use information between mobile communication terminals comprising short-range wireless communication units and system implementing the same.

To accomplish the above objects, a method is provided for synchronizing use information between a first mobile communication terminal and a second mobile communication terminal including short-range wireless communication units and a system comprising first and second mobile communication terminals. An exemplary implementation of the present invention comprises requesting connection for use information synchronization to the second mobile communication terminal by the first mobile communication terminal, if a response signal to the connection request is received from the second mobile communication terminal, transmitting use information of the first mobile communication terminal to the second mobile communication terminal, and updating use information of the second mobile communication terminal by using the transmitted use information of the first mobile communication terminal.

### BRIEF DESCRIPTION OF THE DRAWINGS

The above and other exemplary objects, features and advantages of the present invention will be more apparent from the following detailed description taken in conjunction with the accompanying drawings, in which:

FIG. 1 is a block diagram illustrating a structure of a mobile communication terminal including a short-range wireless communication unit according to an exemplary embodiment of the present invention; and

FIG. 2 is a flowchart illustrating a procedure of synchronizing use information of a first mobile communication terminal with use information of a second mobile communication terminal according to an exemplary embodiment of the present invention.

Throughout the drawings, like reference numerals will be understood to refer to like parts, components and structures.

### DETAILED DESCRIPTION OF EXEMPLARY EMBODIMENTS

Hereinafter, exemplary embodiments of the present invention will be described in detail with reference to the accompanying drawings.

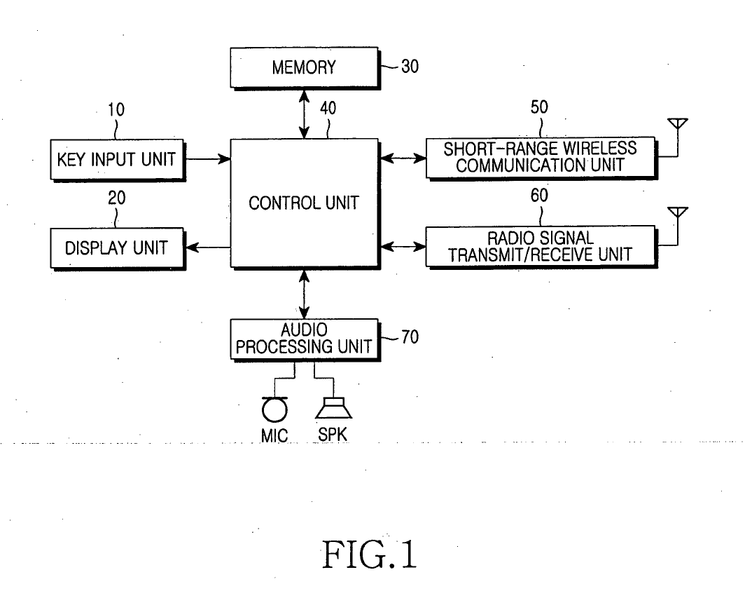

FIG. 1 is a block diagram illustrating a structure of a mobile communication terminal comprising a short-range wireless communication unit according to an exemplary embodiment of the present invention.

The mobile communication terminal shown in FIG. 1 comprises a key input unit 10, a display unit 20, a memory 30, a control unit 40, a short-range wireless communication unit 50, a radio signal transmit/receive unit 60, and an audio processing unit 70.

The key input unit 10, having a key matrix structure (not shown) and comprising character keys, numeral keys, and a variety of function keys, outputs a key input signal corresponding to a key pressed by a user to the control unit 40. In addition, the key input unit 10 includes a key set for a user information synchronization request according to an exemplary embodiment of the present invention.

The display unit 20 may include a liquid crystal display (LCD) device and the like and output various display data generated in the mobile communication terminal.

In addition, although it is not shown in FIG. 1, the display unit 20 may output On Screen Display (OSD) data according to the size of a screen displayed by using an image processing unit (not shown) having an OSD function.

The memory 30 stores various types of information necessary for controlling the operation of the mobile communication terminal according to an exemplary embodiment of the present invention. In addition, the memory 30 stores information regarding the use of the mobile communication terminal comprising memo record of a user, a communication record list, a phone directory, and a transmitted/received message under the control of the control unit 40.

The control unit 40 controls the overall operation of the mobile communication terminal according to an exemplary embodiment of the present invention. In addition, the control unit 40 requests connection for use information synchronization to the other party's mobile communication terminal through the short-range wireless communication unit 50 in response to user request, such as input of a key set to synchronize use information, or input of a key through a menu. The control unit 40 can request the connection for the use information synchronization to the other party's mobile communication terminal whenever a predetermined time period expires or new use information is generated in the mobile communication terminal. According to an exemplary implementation, the connection request aims at forming a data link used for transmitting/receiving use information between the mobile communication terminal and the other party's mobile communication terminal.

If the control unit 40 receives a response signal to the connection request from the other party's mobile communication terminal (that is, the data link is formed), the control unit 40 transmits the use information stored in the memory 30 to the other party's mobile communication terminal by controlling the short-range wireless communication unit 50, so that the use information may be synchronized with that of the other party's mobile communication terminal. According to an exemplary implementation, if the version of the transmitted use information is more up-to-date than that of use information stored in the other party's mobile communication terminal, the other party's mobile communication terminal updates its own use information by using the transmitted use information.

In the meantime, if the control unit 40 receives a connection request for use information synchronization from the other party's mobile communication terminal, the control unit 40 transmits a response signal to the connection request.

After the control unit 40 forms a data link used for transmitting/receiving use information in response to the connection request of the other party's mobile communication terminal, if use information is received from the other party's mobile communication terminal, the control unit 40 determines if the received use information is more up-to-date than use information already stored in the memory 30. In other words, the control unit 40 determines if the received use information has the latest version. Thereafter, if the received use information is not more up-to-date than the use information stored in the memory 30 as the determination result, the control unit 40 transmits the use information stored in the memory 30 to the other party's mobile communication terminal.

The control unit 40 updates the use information stored in the memory 30 if the received use information is more up-to-date than the use information stored in the memory 30 as the determination result. According to an exemplary implementation, it is preferred that, after the use information is completely updated, the control unit 40 controls a signal of reporting the update completion to be transmitted to the other party's mobile communication terminal.

In order to synchronize use information, the short-range wireless communication unit 50 constructs a data link with the other party's mobile communication terminal comprising a short-range wireless communication unit so as to make data communication. The short-range wireless communication unit 50 may comprise a Bluetooth transceiver or an infrared data transceiver (IrDT). According to an exemplary implementation, the short-range wireless communication unit 50 is detachably assembled with the mobile communication terminal.

The radio signal transmitting/receiving unit 60 (a radio frequency (RF) processing unit) may be implemented as, for example, a component comprising a high-frequency processing unit (not shown), a middle-frequency processing unit (not shown), and a baseband processing unit (not shown). The radio signal transmitting/receiving unit 60 transmits/receives voice data, character data, video data, and control data under the control of the control unit 40.

The audio processing unit 70 may be constructed by using a codec comprising a data codec (not shown) for processing packet data, etc., and an audio codec (not shown) for processing an audio signal such as a voice signal.

The audio processing unit 70 converts an electrical signal input from a microphone into voice data by modulating the electrical signal. The audio processing unit 70 demodulates coded voice data input from the radio signal transmitting/receiving unit 60 into an electrical signal and outputs the electrical signal to a speaker. According to an exemplary implementation, the audio processing unit 70 comprises a codec for converting a digital audio signal received from the radio signal transmitting/receiving unit 60 into an analog signal to be reproduced or converting an analog signal generated from the microphone into a digital audio signal.

The codec has a data codec for processing packet data and the like and an audio codec for processing an audio signal such as a voice signal and may be included in the control unit 40.

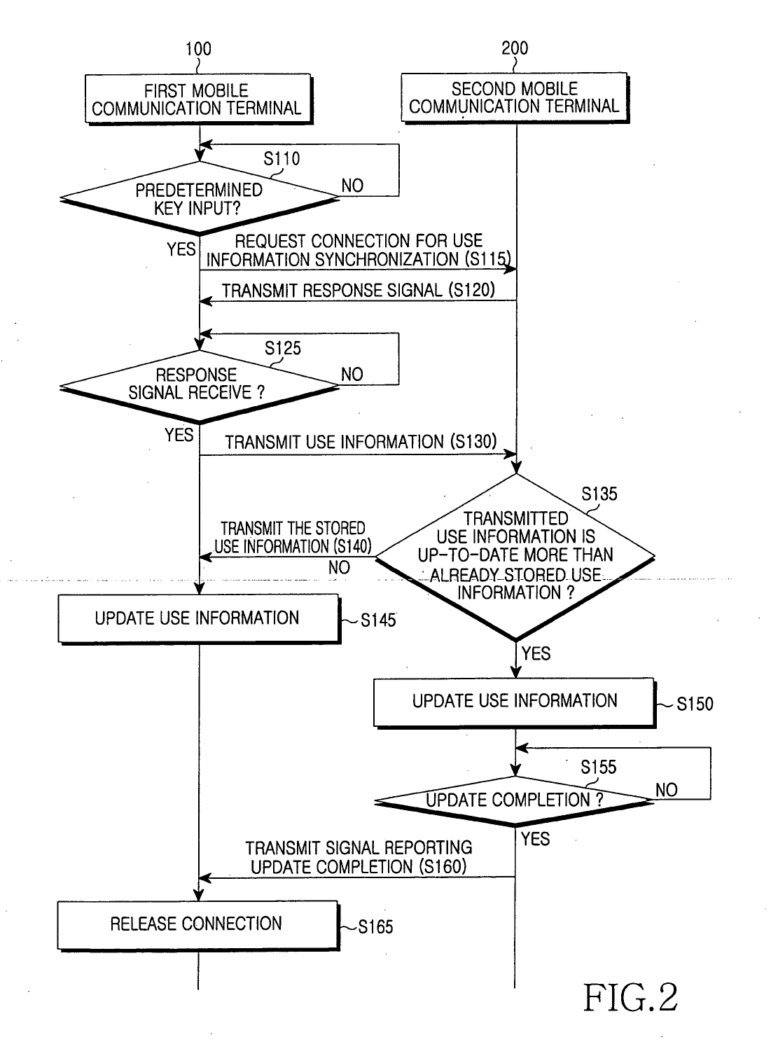

FIG. 2 is a flowchart illustrating a procedure of synchronizing use information of a first mobile communication terminal 100 with use information of the other party's mobile communication terminal 200 according to an exemplary embodiment of the present invention.

Herein, it is assumed that the first mobile communication terminal 100 and the other party's mobile communication terminal 200 have short-range wireless communication units such as Bluetooth modules or infrared modules and store their own use information according to an exemplary embodiment of the present invention. Also, the first mobile communication terminal 100 and the other party's mobile communication terminal 200 may be realized by using a mobile communication terminal comprising a Bluetooth module and a Bluetooth terminal linked with the mobile communication terminal through Bluetooth communication.

Referring to FIG. 2, the first mobile communication terminal 100 determines if a predetermined key is pressed in step S110. The predetermined key refers to, for example, an addition key or a predefined key for use information synchronization request.

If the predetermined key is pressed, the first mobile communication terminal 100 requests connection for use information synchronization to the other party's mobile communication terminal 200 in step S115. According to an exemplary implementation, the first mobile communication terminal 100 may request a connection for use information synchronization to the other party's mobile communication terminal 200 whenever a predetermined period arrives or new use information is generated.

After receiving the connection request for the use information synchronization from the first mobile communication terminal 100, the other party's mobile communication terminal 200 transmits a response signal to the connection request to the first mobile communication terminal 100 in step S120.

Thereafter, the first mobile communication terminal 100 determines if the response signal to the connection request is received from the other party's mobile communication terminal 200 in step S125.

In steps S115 to S125, if the other party's mobile communication terminal 200 responds to the connection request of the first mobile communication terminal 100, the first mobile communication terminal 100 and the other party's mobile communication terminal 200 having Blutooth modules as short-range wireless communication units construct a data link to communicate with each other by using a Bluetooth radio signal according to Bluetooth protocols.

After receiving the response signal, the first mobile communication terminal 100 transmits use information stored in a memory of the first mobile communication terminal to the other party's mobile communication terminal 200 in step S130.

After receiving the use information from the first mobile communication terminal 100, the other party's mobile communication terminal 200 determines if the received use information is more up-to-date than use information stored in a memory of the other party's mobile communication terminal 200 in step S135. In other words, the other party's mobile communication terminal 200 determines if the received use information has the latest version.

According to an exemplary implementation, the other party's mobile communication terminal 200 compares/confirms a final update time point of the use information transmitted from the first mobile communication terminal 100 with that of the use information stored in the memory of the other party's mobile communication terminal 200 so as to distinguish upgraded use information.

If the use information transmitted from the first mobile communication terminal 100 is not more up-to-date than the use information stored in the memory of the other party's mobile communication terminal 200 as the determination result, the other party's mobile communication terminal 200 transfers the use information stored in its memory to the first mobile communication terminal 100 in step S140.

After receiving the use information of the other party's mobile communication terminal 200, the first mobile communication terminal 100 updates the use information stored in the memory of the first mobile communication terminal 100 by using the received use information in step S145. In other words, the first mobile communication terminal 100 compares its own stored use information with the received use information of the other party's mobile communication terminal 200, updates its own use information into the latest use information and then releases the connection with the other party's mobile communication terminal 200.

In the meantime, if the use information transmitted from the first mobile communication terminal 100 is more up-to-date than the use information stored in the memory of the other party's mobile communication terminal 200 in step S135, the other party's mobile communication terminal 200 updates the use information stored in its own memory in step S150.

After the other party's mobile communication terminal 200 completes the update of its own use information, the other party's mobile communication terminal 200 transmits a signal for reporting the update completion to the first mobile communication terminal 100 in step S155.

After receiving the signal for reporting the update completion from the other party's mobile communication terminal 200, the first mobile communication terminal 100 releases the connection with the other party's mobile communication terminal 200 in step S160.

As described above, according to the exemplary embodiments of the present invention, use information synchronization is easily achieved between the mobile communication terminals, thereby increasing user convenient.

While the invention has been shown and described with certain exemplary embodiments thereof, it will be understood by those skilled in the art that various changes in form and details may be made therein without departing from the spirit and scope of the invention. Consequently, the scope of the invention should not be limited to the exemplary embodiments, but is defined by the appended claims and equivalents thereof.

What is claimed is:

1. A method for synchronizing use information between a first mobile communication terminal and a second mobile communication terminal comprising short-range wireless communication units, the method comprising the steps of:
requesting connection for use information synchronization to the second mobile communication terminal by the first mobile communication terminal;
if a response signal to the connection request is received from the second mobile communication terminal, transmitting first use information of the first mobile communication terminal to the second mobile communication terminal; and
updating at least one of second use information based on the first use information, and the first use information based on the second use information.

2. The method as claimed in claim 1, wherein at least one of the first and second use information comprises at least one of information regarding user memo records, a communication record list, a phone directory, and transmitted/received messages.

3. The method as claimed in claim 1, wherein, the step of requesting the connection comprises the step of, if a predetermined key for use information synchronization is pressed, performing the requesting of the connection to the second mobile communication terminal.

4. The method as claimed in claim 1, wherein, the step of requesting the connection comprises the step of performing the requesting of the connection to the second mobile communication terminal every determined time period.

5. The method as claimed in claim 1, wherein, the step of requesting the connection comprises the step of performing the requesting of the connection to the second mobile communication terminal whenever new use information is generated.

6. The method as claimed in claim 1, wherein the step of the updating at least one of the first and the second use information comprises the steps of:
determining if the first use information is more up-to-date than the second use information ; and
if the first use information is more up-to-date than the second use information, performing the updating of the second use information.

7. The method as claimed in claim 6, wherein, the step of determining if the first use information is more up-to-date than the second use information comprises the step of comparing a final update time point of the first use information with a final update time point of the second use information.

8. The method as claimed in claim 6, wherein the step of updating the second use information further comprises the step of:
transmitting a signal for reporting update completion of the second use information.

9. The method as claimed in claim 6, wherein the step of updating the use information stored in the memory further comprises the step of:
if the first use information is not more up-to-date than the second use information, transmitting the second use information to the first mobile communication terminal.

10. The method as claimed in claim 9, further comprising the step of:
performing the updating of the first use information.

11. A system comprising:
a first mobile communication terminal comprising a first memory for storing first use information; and
a second mobile communication terminal comprising a second memory for storing second use information;
wherein, when the connecting the first and second terminal at least one of: the second use information is updated based on the first use information, if the first use information is more up-to-date than the second use information; and
the first use information is updated based on the second use information, if the second use information is more up-to-date than the first use information.
